(19) United States
(12) Patent Application Publication
(10) Pub. No.: US 2024/0413870 A1
(43) Pub. Date: Dec. 12, 2024

(54) BEAM BLOCKAGE PREDICTION AND REPORTING

(71) Applicant: QUALCOMM Incorporated, San Diego, CA (US)

(72) Inventors: Qiaoyu LI, Beijing (CN); Vasanthan RAGHAVAN, West Windsor Township, NJ (US); Mahmoud TAHERZADEH BOROUJENI, San Diego, CA (US); Tao LUO, San Diego, CA (US); Junyi LI, Greentown, PA (US); Sony AKKARAKARAN, Poway, CA (US); Fang YUAN, Beijing (CN); Wooseok NAM, San Diego, CA (US); Arumugam CHENDAMARAI KANNAN, San Diego, CA (US); Juan MONTOJO, San Diego, CA (US); Peter GAAL, San Diego, CA (US)

(21) Appl. No.: 18/699,860

(22) PCT Filed: Dec. 22, 2021
(86) PCT No.: PCT/CN2021/140358

§ 371 Date: Apr. 9, 2024

(51) Int. Cl. H04B 7/06; H04B 17/318; H04L 5/00

(52) U.S. Cl. CPC H04B 7/0626; H04B 17/328; H04L 5/0048

(57) ABSTRACT

Methods, apparatuses, and computer readable medium for wireless communication are provided. An example method may include receiving, from a base station, at least one channel status information (CSI) report setting associated with CSI resource setting that configures a set of CSI reference signals (CSI-RS resources), at least one CSI report setting including at least one quantity change rate associated with one or more predicted quantities over at least one future time window or one or more measured quantities over at least one past time window, one or more predicted quantities or one or more measured quantities being associated with the set of CSI-RS resources. The example UE may further include transmitting, to the base station based on at least one CSI report setting, the quantity change rate or reliability information message based on one or more predicted quantities over at least one future time window.

### TECHNICAL FIELD

The present disclosure relates generally to communication systems, and more particularly, to wireless communication systems with beams.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a base station, at least one channel status information (CSI) report setting associated with a CSI resource setting that configures a set of CSI reference signal (CSI-RS) resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources. The memory and the at least one processor coupled to the memory may be further configured to transmit, to the base station based on the at least one CSI report setting, the quantity change rate or a reliability information message being based on the one or more predicted quantities over the at least one future time window.

In another aspect of the disclosure, a method, a computer-readable medium, and an apparatus at a base station are provided. The apparatus may include a memory and at least one processor coupled to the memory. The memory and the at least one processor coupled to the memory may be configured to transmit, to a UE, a CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources. The memory and the at least one processor coupled to the memory may be further configured to receive, from the UE based on the at least one CSI report setting, the predicted quantities or a reliability information message based on the one or more predicted quantities over the at least one future time window.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a base station in communication with a UE via a set of beams.

FIG. 5 is a diagram illustrating an example beam failure detection (BFD) procedure.

FIG. 6 is a diagram illustrating example beam blockage prediction.

FIG. 7 is a diagram illustrating example beam blockage prediction.

FIG. 8 is a diagram illustrating example received signal strength indicator (RSSI) associated with link degradation.

FIG. 9 is a diagram illustrating example reference signal received power (RSRP) associated with link degradation.

FIG. 10 is a diagram illustrating example communications between a base station and a UE.

FIG. 11 is a diagram illustrating example beam blockage prediction reporting.

FIG. 12 is a diagram illustrating example beam blockage prediction reporting.

FIGS. 13A and 13B are diagrams illustrating example beam blockage prediction reporting.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus.

FIG. 19 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

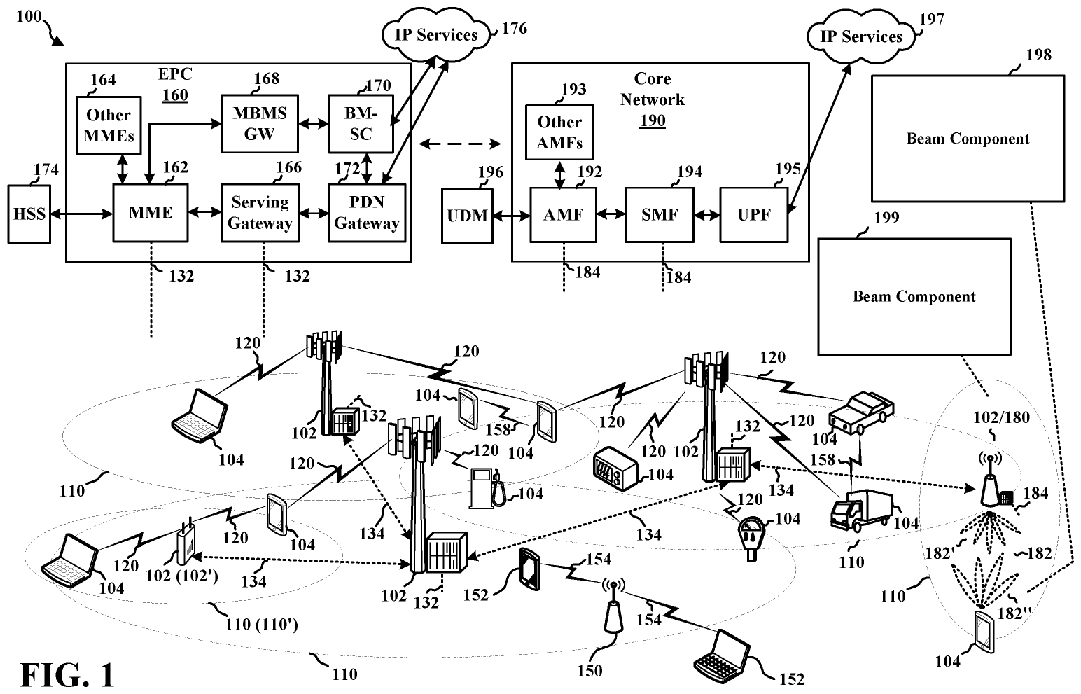

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a beam component 198. In some aspects, the beam component 198 may be configured to receive, from a base station, at least one CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources. In some aspects, the beam component 198 may be further configured to transmit, to the base station based on the at least one CSI report setting, the quantity change rate or a reliability information message based on the one or more predicted quantities over the at least one future time window.

In certain aspects, the base station 180 may include a beam component 199. In some aspects, the beam component 199 may be configured to transmit, to a UE, a CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources. In some aspects, the beam component 199 may be further configured to receive, from the UE based on the at least one CSI report setting, the predicted quantities or a reliability information message based on the one or more predicted quantities over the at least one future time window.

Although the following description may be focused on 5G NR, the concepts described herein may be applicable to other similar areas, such as LTE, LTE-A, CDMA, GSM, and other wireless technologies.

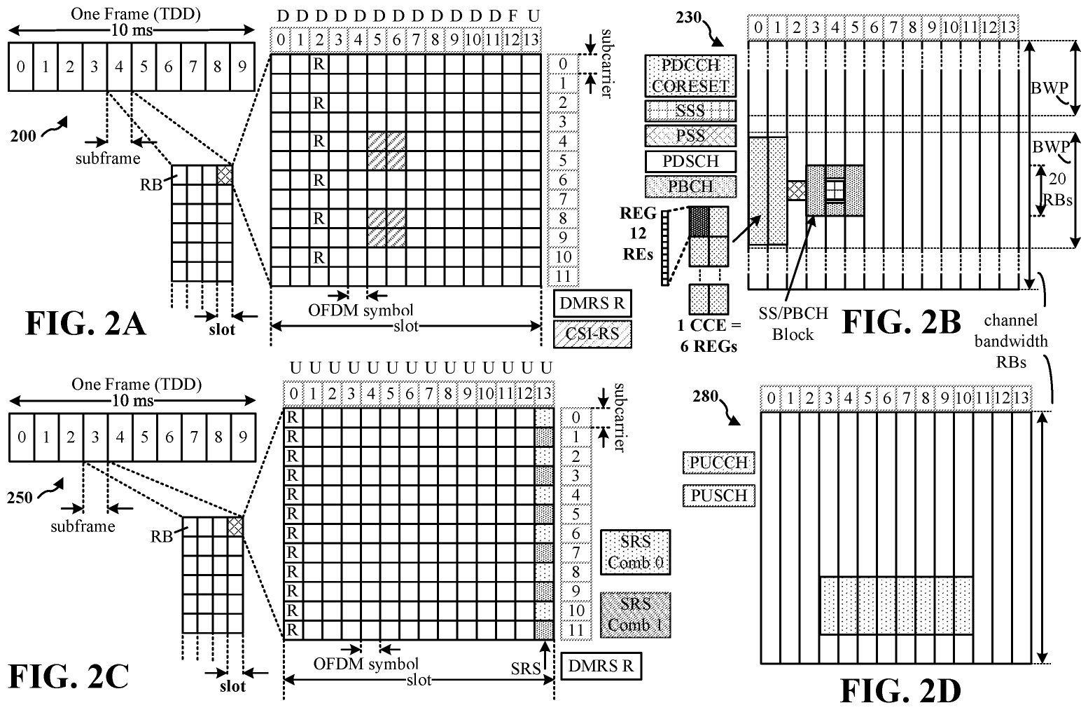

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ*15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

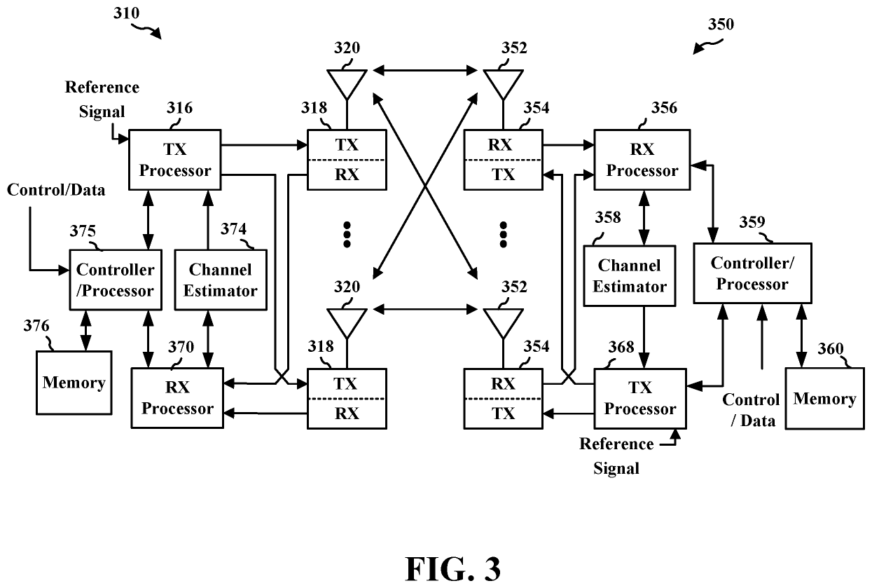

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with beam component 198 of FIG. 1.

At least one of the TX processor 316, the RX processor 370, and the controller/processor 375 may be configured to perform aspects in connection with beam component 199 of FIG. 1.

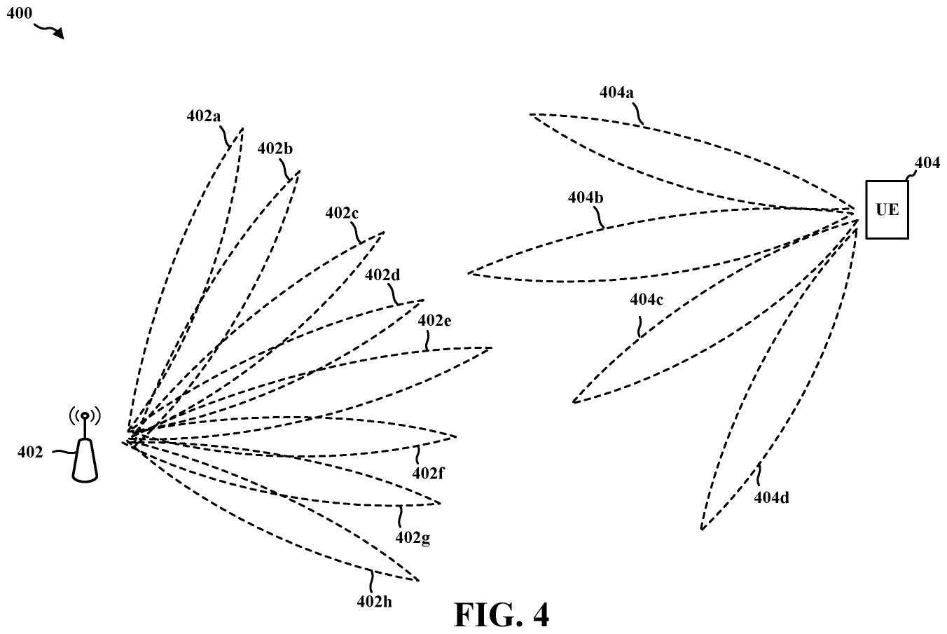

FIG. 4 is a diagram 400 illustrating a base station 402 in communication with a UE 404 via a set of beams. Referring to FIG. 4, the base station 402 may transmit a beamformed signal to the UE 404 in one or more of the directions 402a, 402b, 402c, 402d, 402e, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-504d. The base station 402 may receive the beamformed signal from the UE 404 in one or more of the receive directions 402a-502h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same. The term beam may be otherwise referred to as “spatial filter.” Beamforming may be otherwise referred to as “spatial filtering.”

In response to different conditions, the UE 404 may determine to switch beams, e.g., between beams 402a-502h. The beam at the UE 404 may be used for reception of downlink communication and/or transmission of uplink communication. In some examples, the base station 402 may send a transmission that triggers a beam switch by the UE 404. A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TC state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the base station 402 may indicate a TCI state change, and in response, the UE 404 may switch to a new beam (which may be otherwise referred to as performing a beam switch) according to the new TCI state indicated by the base station 402.

In some wireless communication systems, such as a wireless communication system under a unified TCI framework, a pool of joint DL/UL TCI states may be used for joint DL/UL TCI state updates for beam indication. For example, the base station 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the base station 402 may use RRC signaling to configure the TCI state pool. In some aspects, the joint TCI may or may not include UL specific parameter(s) such as UL PC/timing parameters, PLRS, panel-related indication, or the like. If the joint TCI includes the UL specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 4 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on a PDSCH and a subset (which may be a full set) of control resource sets (CORESETs), or the like.

Before receiving a TCI state, a UE may assume that the antenna ports of one DM-RS port group of a PDSCH are spatially quasi-co-located (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, a maximum number of TCI states may be 128.

In some aspects, a UE may receive a signal, from a base station, configured to trigger a TCI state change via, for example, a medium access control (MAC) control element (CE) (MAC-CE), downlink control information (DCI), or a radio resource control (RRC) signal. The TCI state change may cause the UE to find a best or most suitable UE receive beam corresponding to the TCI state indicated by the base station, and switch to such beam. Switching beams may allow for an enhanced or improved connection between the UE and the base station by ensuring that the transmitter and receiver use the same configured set of beams for communication.

In some aspects, a spatial relation change, such as a spatial relation update, may trigger the UE to switch beams. Beamforming may be applied to uplink channels, such as a PUSCH, a PUCCH, or an SRS, or downlink channels, such as a PDCCH, a PDSCH, or the like. Beamforming may be based on configuring one or more spatial relations between the uplink and downlink signals. Spatial relation indicates that a UE may transmit the uplink signal using the same beam used for receiving the corresponding downlink signal.

The UE 404 may monitor the quality of the beams that it uses for communication with a base station. The UE 404 may monitor a quality of a signal received via reception beam(s). A BFD procedure may be used to identify problems in beam quality and BFR may be used when a beam failure is detected. For monitoring active link performances, the UE 404 may perform measurements of at least one signal, e.g., reference signals, for beam failure detection. For example, the UE 404 may monitor one or more BFD RSs configured by the base station 402, such as periodic CSI-RS or SSB spatially QCLed with a PDCCH DM-RS, to assess if a beam failure trigger condition is met. Example measurements may include RSRP measurement, reference signal received quality (RSRQ) measurement, signal-to-interference plus noise (SINR) measurement, channel quality indicator (CQI) measurement, rank indicator (RI) measurement, or the like. The UE 404 may further monitor beam identification RS (such as periodic CSI-RS for beam management and SSB associated with a serving cell) to find a new candidate beam. Based on one or more metrics, such as layer 1 (L1) RSRP, a candidate beam may be identified. By way of example, CSI-RS, synchronization signal (SS) block, or a combination of CSI-RS and SS block, may be used for finding a candidate beam. In some aspects, there may be an association between CSI-RS or SSB resources and contention free random access channel (RACH) resources.

The UE 404 may transmit a beam failure recovery request (BFRQ) to the base station 402 based on one or more BFRQ-transmit (TX) conditions, such as a hypothetical PDCCH block error ratio (BLER) being above a threshold for a configured number of times. A channel for contention-free RACH cloud data management (CDM) may be used. The UE 404 may then monitor a response of the BFRQ from the base station 402. The base station 402's response may be transmitted via a PDCCH and may be scrambled with cell radio network temporary identifier (C-RNTI). A monitor time window and dedicated control resource sets (CORESETs) (e.g., QCLed with the indicated beam in BFRQ) response may be RRC configured. The UE 404 may assume a PDSCH DMRS to be QCLed with a BFRQ indicated beam, until being further updated with new TCI-states. Unsuccessful BFR may further trigger upper-layer radio link failure procedures.

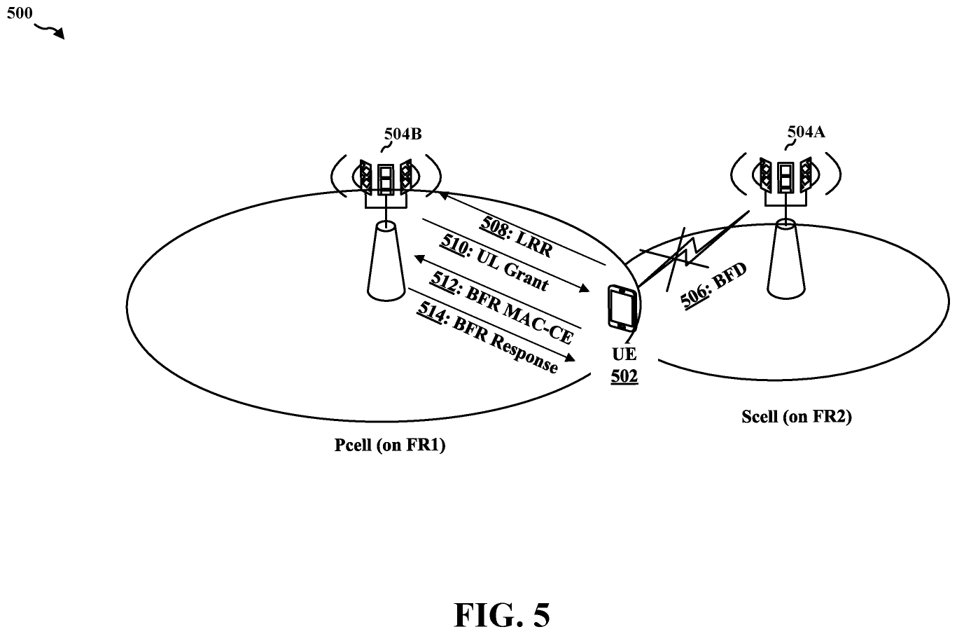

FIG. 5 is a diagram 500 illustrating an example BFD procedure between a UE 502 and base stations 504A and 504B. As illustrated in FIG. 5, at 506, the UE 502 may detect that one or more (such as all) DL control beams have failed for an SCell on FR2 (e.g., associated with a first base station 504A). The detection may be based on SCell beam failure detection RS such as periodic CSI-RS configured by RRC (e.g., explicitly) or by PDCCH TCI-states (e.g., implicitly). The PDCCH BLER threshold may also be used. For example, the UE 502 may determine that a PDCCH BLER may be above the threshold for a configured number of times. At 508, the UE 502 may transmit a link recovery request (LRR) to a second base station 504B. The LRR may be sent on PCell on FR1 via corresponding PUCCH resource. The LRR may also be configured in SCell on FR2. The LRR may be configured as PUCCH format 0 or 1 as regular scheduling request (SR). At 510, the base station 504B, such as a PCell associated with the base station 504B, may allocate UL grant for the UE 502 to report a failed SCell index. The UL grant may be associated with C-RNTI or modulation and coding scheme-C-RNTI (MCS-C-RNTI). At 512, the UE 502 may transmit an SCell BFR MAC-CE to report a failed SCell index and potential new candidate beams. In some aspects, the BFR MAC-CE may carry a failed SCell index and a new candidate beam (such as one beam without RSRP). Steps 510 and 512 may be skipped if the UE 502 has a UL grant. In some aspects, the UE 502 may report no beam if no candidate beam has a RSRP greater than a threshold. In some aspects, the base station 504B, such as a PCell associated with the base station 504B, may reply with a BFR response, acknowledging the reception of BFR MAC-CE. The BFR response may include an UL-grant to schedule a new UL-Tx for the same HARQ process as the PUSCH carrying the MAC-CE.

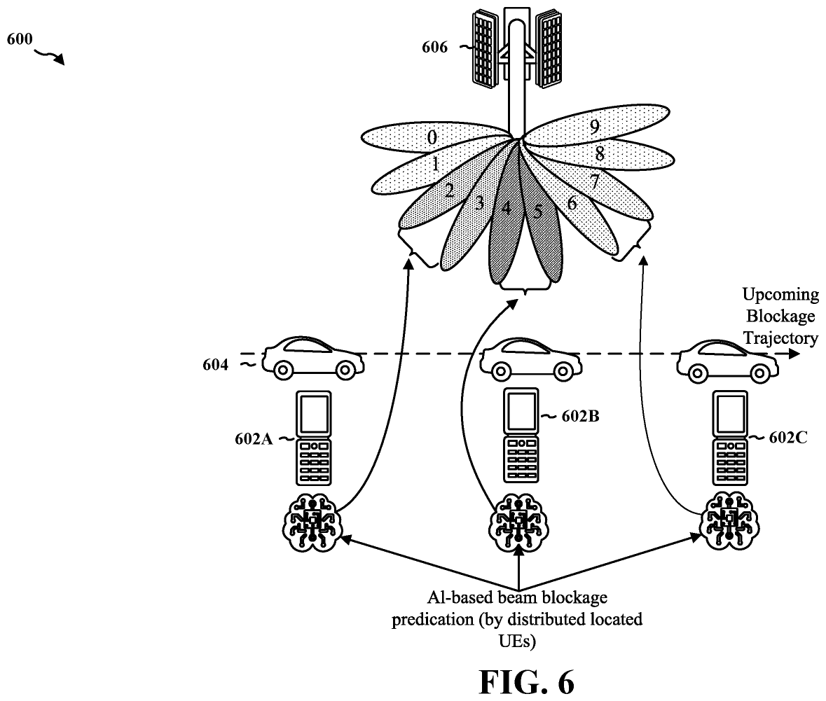

A beam may fail for a variety of reasons that may be known by the UE. Beam blockage may be predicted by UEs to prevent or reduce future beam failure or enable faster future BFR. For example, a UE may be able to predict a beam blockage via machine learning techniques or statistical signal processing, via monitored beams, or via external assistance such as active/passive sensing, camera based assistant information, or vehicle approaching information via C-V2X. FIG. 6 is a diagram 600 illustrating example beam blockage prediction. As illustrated in FIG. 6, a UE 602A, a UE 602B, and a UE 602C may be in communication with a base station 606 and may include a beam blockage prediction functionality (e.g., which may be artificial intelligence (AI) based). As a vehicle 604 moves, beams 2 and 3, beams 4 and 5, or beams 6 and 7 may be blocked by the vehicle 604, causing beam blockage for the UE 602A, the UE 602B, and the UE 602C. The UE 602A, the UE 602B, and the UE 602C may be able to predict the beam blockage based on location information associated with the UE, the base station 606, the vehicle 604, and movement information associated with the vehicle 604.

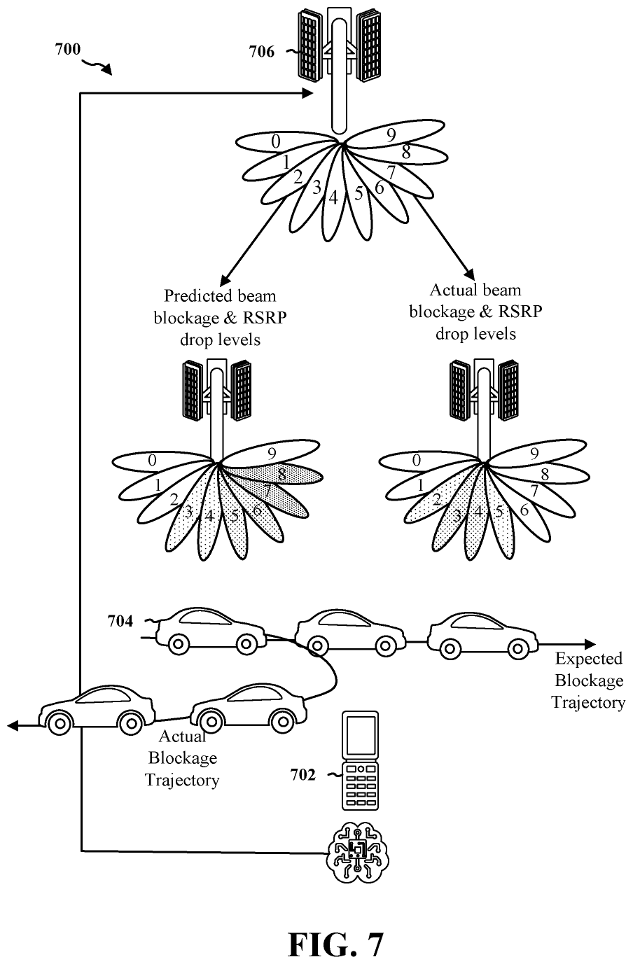

In some wireless communication systems, BFRQ are used for addressing beam failures that already happened. Example aspects provided herein may provide signaling mechanisms for supporting reporting of predicted future beam blockage and future candidate beams, reducing beam failures or enabling faster BFR in the future, hence improving communication efficiency. In some examples, the predicted blocked beams' RSRP may not drop suddenly and significantly, but rather gradually with a slope. In addition, there may be uncertainty or reliability associated with the prediction. FIG. 7 is a diagram 700 illustrating example beam blockage prediction. As illustrated in FIG. 7, a UE 702 may be in communication with a base station 706. A vehicle 704 may be expected to move in an expected trajectory and may be expected to block beams 3, 4, 5, 6, 7, and 8 over time. However, the vehicle 704 may move in an actual trajectory that may be different from the expected trajectory and may block beams 4, 5, 2, and 3 over time instead. As shown in FIG. 7, the blockage trajectory may change and make the actual beam blockage pattern (blocked beam-indexes and RSRP drop levels) different from the predicted one. For example, the predicted blocked/candidate beams may vary with time/environment changing. Example aspects provided herein may enable the UE to report predicted future beam blockage/failure, and future candidate beams associated with the predicted beam blockage events.

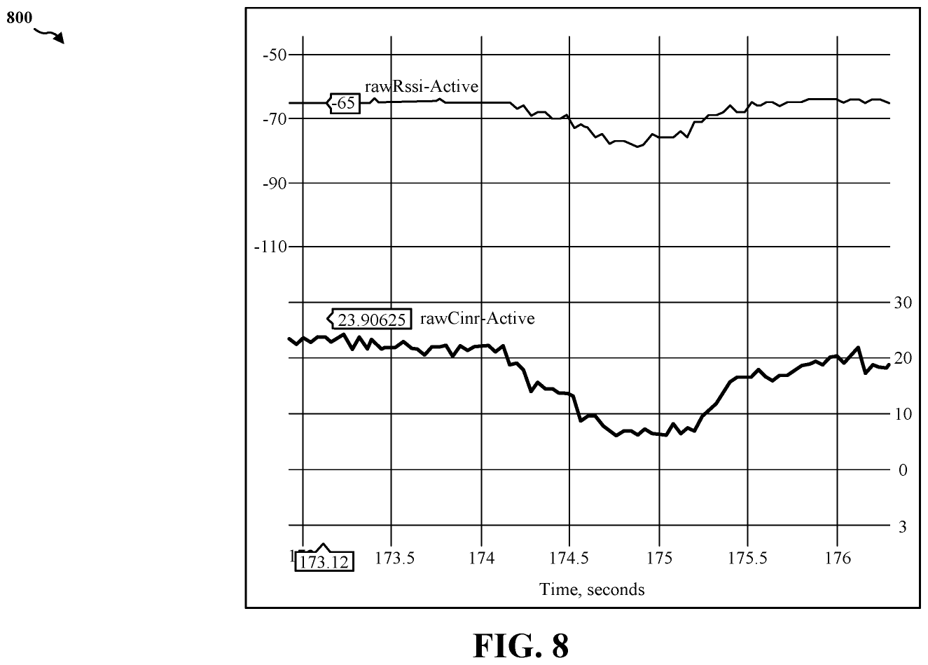

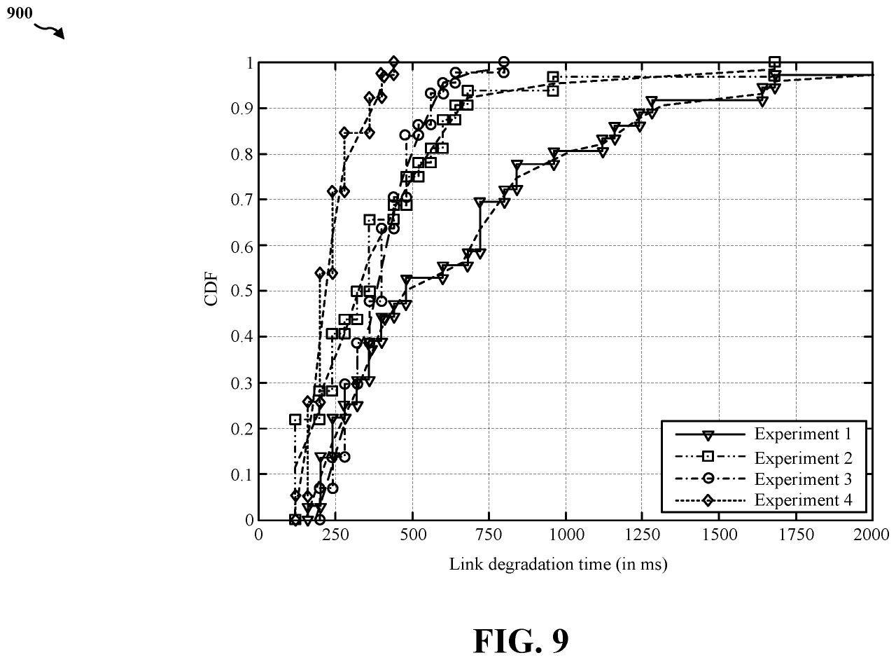

FIG. 8 is a diagram 800 illustrating example RSSI associated with link degradation. FIG. 9 is a diagram 900 illustrating example RSRP associated with link degradation. As illustrated in FIG. 8, degradation may happen at a rate of less than 0.4 decibels (dB) per millisecond (ms). A link degradation time may be defined as the time taken for RSSI or RSRP to drop from its steady state value to its minima or loss of link. As illustrated in FIG. 9, median of link degradation time may range from 200 ms to 500 ms in different link degradation experiments.

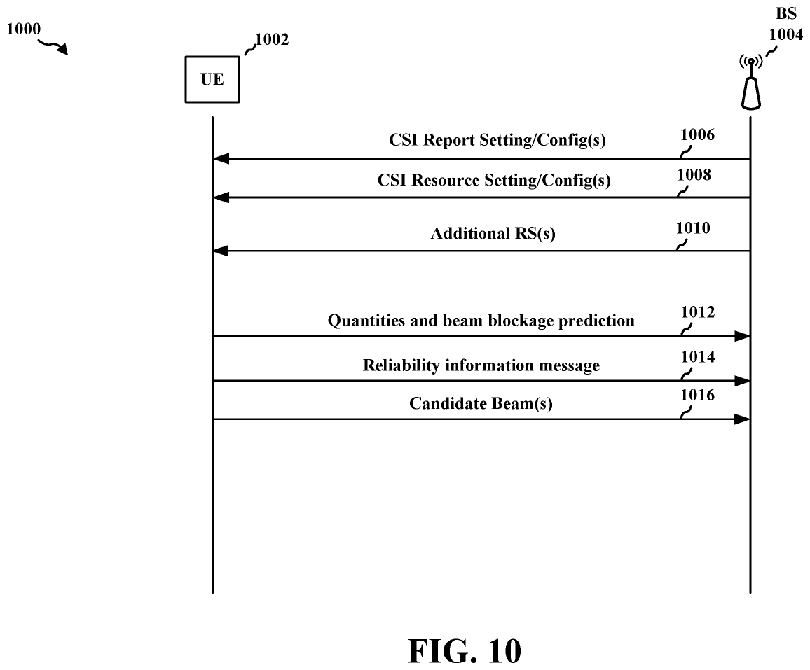

FIG. 10 is a diagram 1000 illustrating example communications between a base station 1004 and a UE 1002. As illustrated in FIG. 10, the UE 1002 may be configured with (and receive) one or more CSI report settings or configurations 1006 by the base station 1004. In some aspects, the one or more CSI report settings or configurations 1006 may correspond with one or more CSI-ReportConfig information elements. In some aspects, the one or more CSI report settings or configurations 1006 may correspond with one or more CSI report settings. In some aspects, the one or more CSI report settings or configurations 1006 may be associated with one or more CSI resource settings or configurations 1008. The UE 1002 may be configured with (and receive) the one or more CSI resource settings or configurations 1008 by the base station 1004. In some aspects, the one or more CSI resource settings or configurations 1008 may correspond with one or more CSI-ResourceConfig information elements. In some aspects, the one or more CSI resource settings or configurations 1008 may correspond with one or more CSI resource settings.

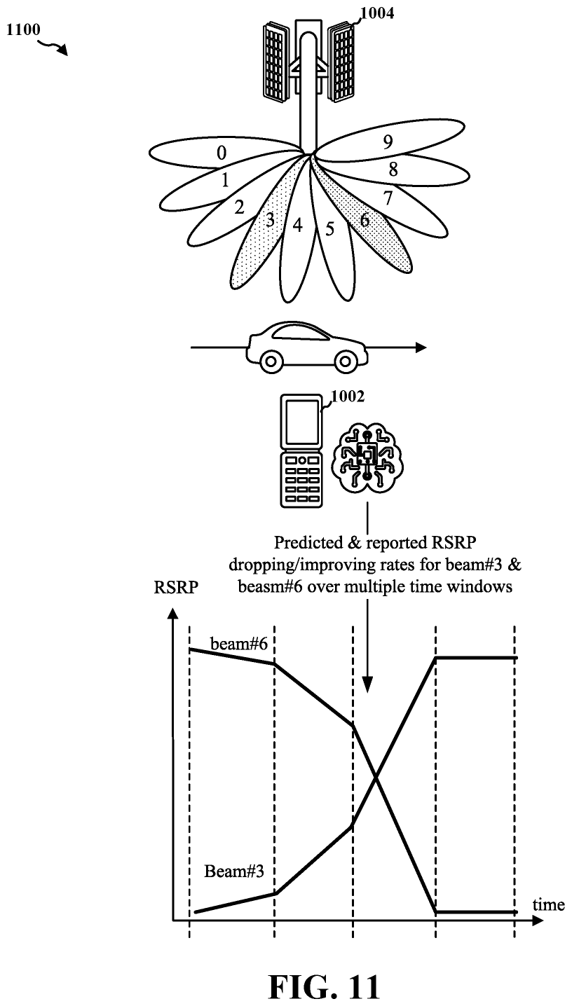

In some aspects, the one or more CSI report settings or configurations 1006 may configure one or more reported quantities, such as an L1-RSRP, SINR, CQI, or RI dropping or improving rate over a history or future time window. In some aspects, the UE 1002 may transmit the one or more reported quantities and a beam blockage prediction 1012 based on the one or more CSI report settings or configurations 1006 and the one or more CSI resource settings or configuration 1008 to the base station 1004. The beam blockage prediction may be based on RSs configured by the one or more CSI resource settings or configurations 1008 or additional RSs 1010. FIG. 11 is a diagram 1100 illustrating example beam blockage prediction reporting. Referring to FIG. 11, history or predicted RSRP dropping/improving rate associated with beams 3/6 (and associated CSI-RS) may be 3 dB per 100 ms over an upcoming time window of one second duration.

In some aspects, the one or more reported quantities configured by the one or more CSI report settings or configurations 1006 and reported in 1012 may further include RSRP/SINR/CQI/RI predicted for the start/end of the time window. In some aspects, the one or more reported quantities configured by the one or more CSI report settings or configurations 1006 and reported in 1012 may further include history or predicted L1-RSRP/SINR/CQI/RI mean value over the time window. In some aspects, the dropping/improving rate may be expressed by curve fitting to polynomial function(s). In some aspects, the dropping/improving rate may also be expressed by multiple RSRP values associated with various time instances (e.g., within the time window(s)). In some aspects, the one or more reported quantities configured by the one or more CSI report settings or configurations 1006 and reported in 1012 may further include Doppler or velocity information associated with the beam blockage prediction (which may be based on the RSs in the one or more CSI resource settings or configurations 1008 or the one or more additional RSs 1010).

In some aspects, the UE 1002 may further transmit a reliability information message 1014 to the base station 1004. In some aspects, the reliability information message 1014 may be based on at least one of: a reliability represented by a percentage value associated with a beam, one or more variances of the predicted dropping/improving rate(s), one or more confidence level and/or confidence intervals of the predicted dropping/improving rate(s). In some aspects, if multiple time windows are respectively reported with different dropping rates, multiple confidence levels and/or confidence intervals may be reported and associated with the dropping rates predicted for the multiple time windows. In some aspects, time window lengths and starting/ending points may be reported by the UE 1002, configured by the base station 1004, or defined without signaling from the UE 1002 or the base station 1004. In some aspects, one or more reports carrying the one or more reported quantities in 1012 may be over multiple time windows with respective associated report quantities. In some aspects, based on UE 1002's recommendation, the base station 1004's configuration, or a definition without signaling from the UE 1002 or the base station 1004, history or predicted quantities of the one or more reported quantities, such as L1-RSRP/SINR/CQI/RI, may be processed using L1 filtering methods.

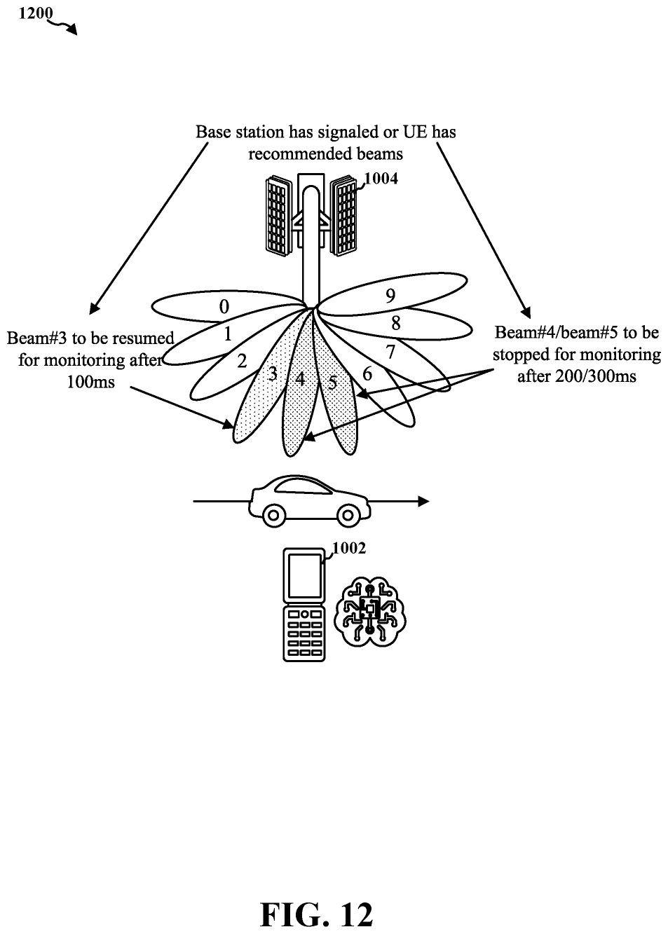

In some aspects, the RSs associated with the one or more reported quantities in 1012, such as the one or more RSs configured by the one or more CSI resource settings or configurations 1008, may be periodically (P), semi-persistently (SPS), or dynamically recommended by the UE 1002 or configured/indicated by the base station 1004. In some aspects, the RSs associated with the one or more reported quantities in 1012, such as the one or more RSs configured by the one or more CSI resource settings or configurations 1008, may be recommended by the UE 1002 or configured/indicated by the base station 1004 and may be associated with stopping or resuming for monitoring for a future time. In some aspects, the UE 1002's recommendation or the base station 1004's configuration may further indicate the timing relationship to stop/resume the monitoring. In some aspects, the base station 1004's configuration may be a command that may indicate the stopping or resuming for monitoring for a future time and the UE 1002 may be further signaled by the command with an expire timer (e.g., represented by an ExpireTimer parameter), to resume monitoring the RS, or to monitor a further resume command after the timer expires. The base station 1004 may configure/indicate a TCI-state associated with the resource including the resume command (e.g., a CORESET or an SPS-PDSCH). FIG. 12 is a diagram 1200 illustrating example beam blockage prediction reporting. As illustrated in FIG. 12, the base station 1004 may configure or the UE 1002 may recommend beam 3 to be resumed for monitoring after 100 ms and recommend beams 4 and 5 to be stopped for monitoring respectively after 200 ms and 300 ms.

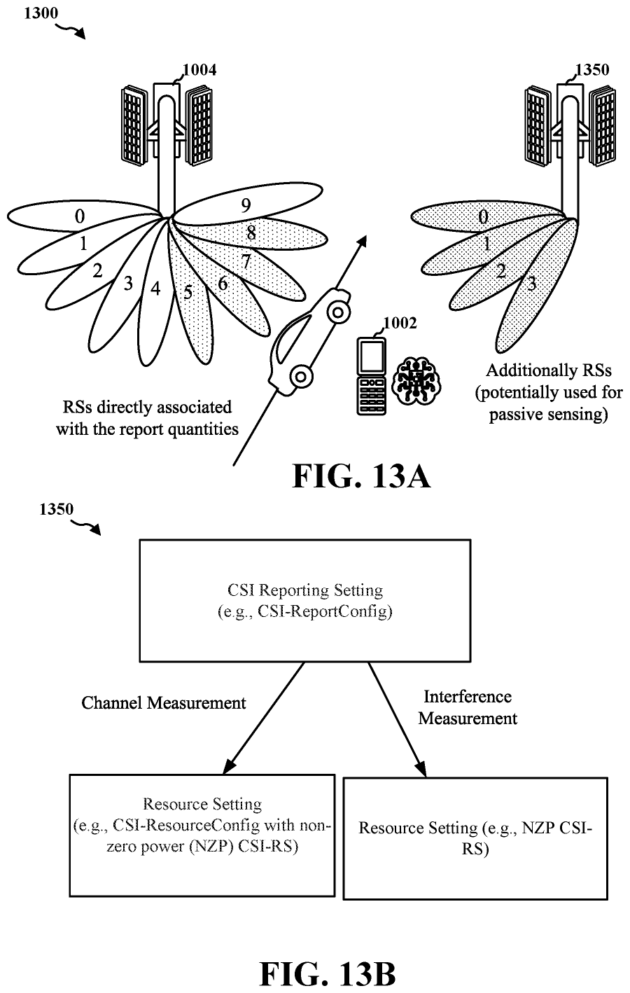

In some aspects, the one or more additional RSs 1010 that may be associated with the beam blockage prediction in 1012 may not be directly associated with the report quantities in 1012. In some aspects, the one or more additional RSs 1010 may be linked with the beam blockage prediction. In some aspects, the one or more additional RSs 1010 may be CSI-RS or cell-specific DM-RS different from the RSs directly associated with the report quantities (e.g., the RSs in 1008). In some aspects, the one or more additional RSs 1010 may be associated with the same cell as the RSs directly associated with the report quantities or associated with another cell. In some aspects, the one or more additional RSs 1010 may be associated with the report quantities in 1012 (e.g., velocity/Doppler information estimated from the one or more additional RSs). In some aspects, the one or more additional RSs may be associated with a passive sensing by the UE 1002 to detect blockage. FIG. 13A is a diagram 1300 illustrating example beam blockage prediction reporting. As illustrated in FIG. 13A, one or more RSs (and associated beams) may be directly associated with the reported quantities and one or more additional RSs (and associated beams) may be used for passive sensing.

In some aspects, P/SPS/dynamic-CSI-reports may be used for beam blockage prediction reporting in 1012, with additional configurations for beam prediction reports that may be configured by the one or more CSI report settings or configurations 1006 or the one or more CSI resource settings or configurations 1008 (e.g., CSI-ReportConfig and/or CSI-ResourceConfig). For example, the additional configurations may include a periodicity and offset that may be based on a longer report periodicity than other P/SPS-CSI-reports (e.g., multi-frames). In some aspects, the additional configurations may include options of RSRP/SINR/CQI/RI dropping/improving rate values, time window lengths, curve-fitting parameters, variance values, confidence level and/or interval values. In some aspects, the additional configurations may be time window specifically configured (e.g., more future time window may be associated with lower confidence level ranges).

In some aspects, beam blockage prediction reports associated with 1012 may be associated with multiple beam prediction RSs or multiple time windows and may be based on one CSI report setting or configuration in the one or more CSI report settings or configurations 1006 or respectively reported based on multiple CSI report settings or configurations in the one or more CSI report settings or configurations 1006, such as one single CSI-ReportConfig or respectively reported based on multiple CSI-ReportConfigs as illustrated in example 1350 of FIG. 13B.

In some aspects, CSI omission/dropping rules regarding the one or more quantities and the beam blockage prediction in 1012 and associated CSI reports may be recommended by the UE 1002, configured by the base station 1004, or defined without signaling from the UE 1002 or the base station 1004. For example, beam blockage prediction reports may be associated with a higher priority than CSI-reports including precoding matrix indicator (PMI) without other parameters. In some aspects, the omission/dropping rules may define dropping/improving rates has higher priority than (represented by “>”) variance of the rates>confidence level and/or interval values>Doppler information. In some aspects, based on a recommendation by the UE 1002 or a configuration by the base station 1004, beam prediction reports for a further (e.g., compared with present time) time window may be associated with a lower priority than reports for a closer (e.g., compared with present time) time window.

In some aspects, the UE 1002 may report one or more candidate beams 1016 to the base station 1004. In some aspects, a beam blockage report in 1012 may be further associated with the one or more candidate beams 1016 (e.g., correspond with candidate RSs) and associated predictions for a future time window. In some aspects, the one or more candidate beams 1016 may also be included in a CSI report configured by the one or more CSI report settings or configurations 1006 configuring the one or more reported quantities. In some aspects, the one or more candidate beams 1016 may be based on the same RSs as the RSs for beam blockage predictions or separate RSs additionally configured by separate CSI report/resource settings/configurations, e.g., separate CSI-ResourceConfig.

In some aspects, the one or more candidate beams 1016 may be separately reported and linked. For example, one or more candidate beams 1016 may be predicted candidate beams (and corresponding predicted RSRPs in some examples) may be separately reported in a CSI-report or MAC-CE, and may be linked with the CSI-report carrying the beam blockage prediction report in 1012. In some aspects, the linkage may be further identified by further configurations within the one or more CSI report settings or configurations 1006 (e.g., CSI-ReportConfig) for beam blockage prediction. In some aspects, the linkage may be performed by linking another CSI-ReportConfig or a MAC-CE identifier (ID). In some aspects, the one or more report quantities in 1012 may be reported with regard to the candidate beams 1016.

In some aspects, a CSI processing unit (CPU) for CSI reports carrying the beam blockage prediction in 1012 may be defined. In some aspects, the number of occupied CPUs carrying the beam blockage prediction in 1012 may be associated with a number of configured RSs (configured by the one or more CSI report settings or configurations 1006) directly associated with the report quantities for a beam blockage prediction report in 1012, the difference between the starting point of the time window and a present time, or the number of additional configured RSs (the additional RSs 1010). In some aspects, X CSI-RS may be configured for a beam blockage prediction report, then the corresponding number of CPUs=aX. The value of a may be defined without base station or UE signaling, configured by the base station 1004, or reported by the UE 1002. The value of X may be a positive integer. In some aspects, the present time may be: 1) based on the last symbol of the PUCCH/PUSCH carrying the report or 2) based on a defined number of symbols after the last symbol of the latest one of each configured RS directly associated with the report quantities (e.g., in 1012). For example, a time window further away from a current time may use more prediction calculation (more CPU) then a time window that is close to the current time. In some aspects, X CSI-RS are configured for a beam block prediction report, while Y CSI-RS are additionally configured for passive sensing, then the corresponding number of CPUs=aX+bY, where the values of a and b may be defined without base station or UE signaling, configured by the base station 1004, or reported by the UE 1002. The value of X may be a positive integer. The time duration where the CPUs may be occupied for the beam blockage prediction may be defined based on the following description.

For a CSI report with CSI-ReportConfig with higher layer parameter reportQuantity not set to ‘none’, the CPU(s) are occupied for a number of OFDM symbols as follows: 1) a periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report; 2) an aperiodic CSI report occupies CPU(s) from the first symbol after the PDCCH triggering the CSI report until the last symbol of the scheduled PUSCH carrying the report; 3) an initial semi-persistent CSI report on PUSCH after the PDCCH trigger occupies CPU(s) from the first symbol after the PDCCH until the last symbol of the scheduled PUSCH carrying the report.

For a CSI report with CSI-ReportConfig with a higher layer parameter reportQuantity set to ‘none’ and CSI-RS-ResourceSet with higher layer parameter trs-Info not configured, the CPU(s) are occupied for a number of OFDM symbols may be as follows: 1) a semi-persistent CSI report (excluding an initial semi-persistent CSI report on PUSCH after the PDCCH triggering the report) occupies CPU(s) from the first symbol of the earliest one of each transmission occasion of periodic or semi-persistent CSI-RS/SSB resource for channel measurement for L1-RSRP computation, until Z₃′ symbols after the last symbol of the latest one of the CSI-RS/SSB resource for channel measurement for L1-RSRP computation in each transmission occasion; 2) an aperiodic CSI report occupies CPU(s) from the first symbol after the PDCCH triggering the CSI report until the last symbol between Z₃ symbols after the first symbol after the PDCCH triggering the CSI report and Z₃′ symbols after the last symbol of the latest one of each CSI-RS/SSB resource for channel measurement for L1-RSRP computation. The value of Z₃, Z₃′ may be defined.

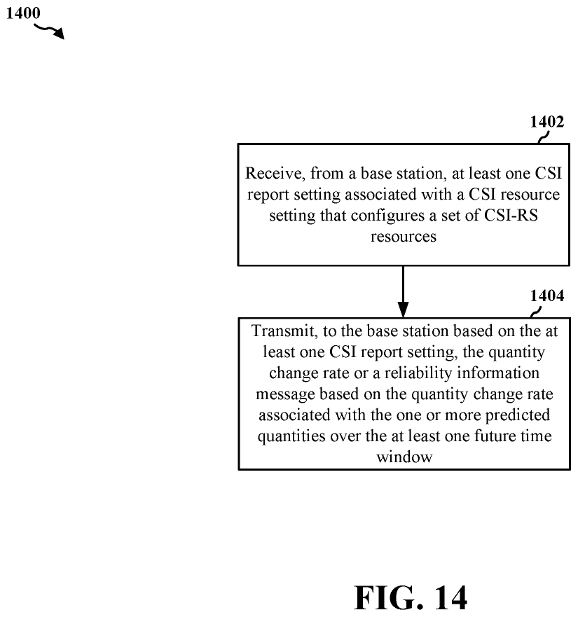

FIG. 14 is a flowchart 1400 of a method of wireless communication. The method may be performed by a UE (e.g., the UE 104, 404, 502, 1002; the apparatus 1802).

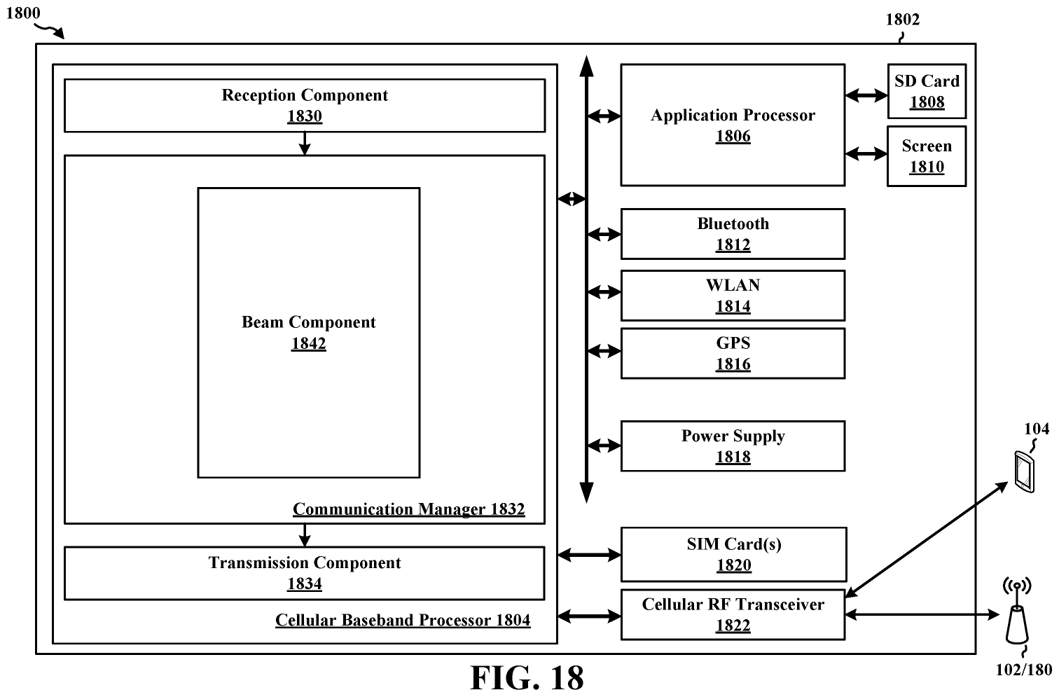

At 1402, the UE may receive, from a base station, at least one CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities may be associated with the set of CSI-RS resources. For example, the UE 1002 may receive, from the base station 1004 at least one CSI report setting (e.g., 1006) associated with a CSI resource setting (e.g., 1008) that configures a set of CSI-RS resources. In some aspects, 1402 may be performed by beam component 1842 in FIG. 18.

At 1404, the UE may transmit, to the base station based on the at least one CSI report setting, the quantity change rate or a reliability information message based on the one or more predicted quantities over the at least one future time window. For example, the UE 1002 may transmit, to the base station based on the at least one CSI report setting, the quantity change rate or a reliability information message based on the one or more predicted quantities over the at least one future time window. In some aspects, 1404 may be performed by beam component 1842 in FIG. 18.

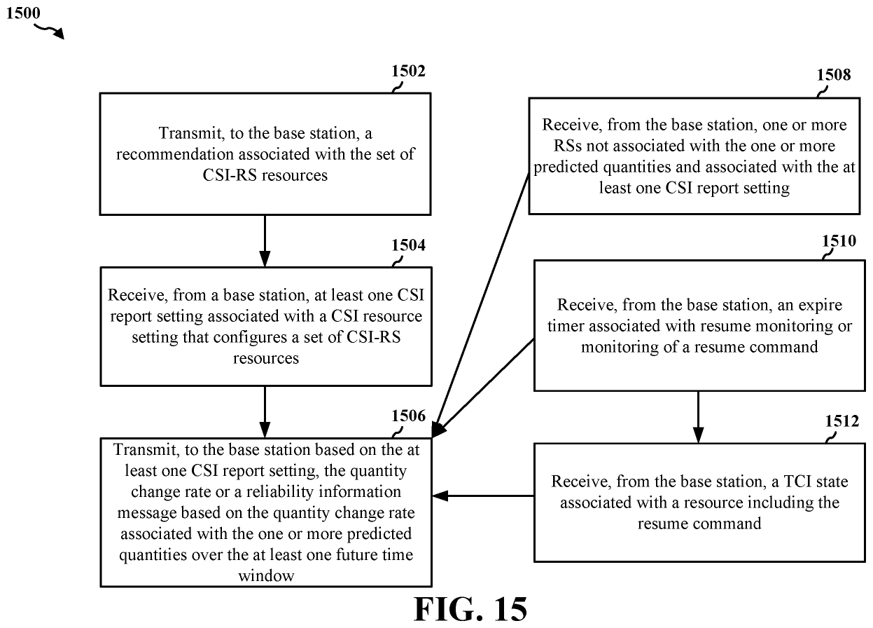

FIG. 15 is a flowchart 1500 of a method of wireless communication. The method may be performed by a UE (e.g., the UE 104, 404, 502, 1002; the apparatus 1802).

At 1502, the UE may transmit, to the base station, a recommendation associated with the set of CSI-RS resources. The set of CSI-RS resources may be configured based on the recommendation. For example, the UE 1002 may transmit, to the base station 1004, a recommendation associated with the set of CSI-RS resources. The set of CSI-RS resources may be configured based on the recommendation. In some aspects, 1502 may be performed by beam component 1842 in FIG. 18. In some aspects, the recommendation or the CSI resource setting may be periodically, semi-persistently, or dynamically transmitted or configured. In some aspects, the recommendation or the CSI resource setting may further indicate a timing relationship associated with a stop or resume associated with a monitoring of the set of CSI-RS resources.

At 1504, the UE may receive, from a base station, at least one CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities may be associated with the set of CSI-RS resources. For example, the UE 1002 may receive, from a base station 1004, at least one CSI report setting (e.g., 1006) associated with a CSI resource setting (e.g., 1008) that configures a set of CSI-RS resources. In some aspects, 1504 may be performed by beam component 1842 in FIG. 18. In some aspects the one or more predicted quantities or the one or more measured quantities may include one or more of: an L1 RSRQ quantity, a SINR quantity, a CQI quantity, or a RI quantity, and each of the L1 RSRQ quantity, the SINR quantity, the CQI quantity, or the RI quantity may include a drop rate or an improve rate. In some aspects, the at least one quantity change rate may be expressed based on curve fitting to at least one polynomial function or one or more RSRQ values associated with one or more time instances within the at least one future time window or the at least one past time window. In some aspects, the at least one quantity change rate may be associated with Doppler or velocity information associated with a blockage estimated based on the set of CSI-RS resources. In some aspects, at least one length, at least one starting point, or at least one ending point associated with the at least one future time window may be configured by the base station or defined without the base station. In some aspects, the set of CSI-RS resources may be associated with a same serving cell.

At 1506, the UE may transmit, to the base station based on the at least one CSI report setting, the quantity change rate or a reliability information message based on the one or more predicted quantities over the at least one future time window. For example, the UE 1002 may transmit, to the base station 1004 based on the at least one CSI report setting (e.g., 1006), the quantity change rate or a reliability information message (e.g., 1012) based on the one or more predicted quantities over the at least one future time window. In some aspects, 1506 may be performed by beam component 1842 in FIG. 18. In some aspects, the reliability information message may be further based on one or more of: a percentage value, a variance associated with the at least one quantity change rate, or one or more confidence levels or one or more confidence intervals associated with the at least one quantity change rate. In some aspects, the one or more predicted quantities or the one or more measured quantities may be further based on an L1 filtering method. The filtering method may be based on a definition without signaling from the UE or the base station, a configuration by the base station, or a recommendation of the UE.

In some aspects, the one or more predicted quantities or the one or more measured quantities may be associated with a periodicity of at least one frame. The one or more predicted quantities or the one or more measured quantities may include one or more of: a beam blockage prediction, an L1 RSRQ quantity, a SINR quantity, a CQI quantity, or a RI quantity, one or more lengths associated with the one or more time windows, one or more curve-fitting parameters, one or more variance values, one or more confidence levels or confidence intervals. The one or more predicted quantities or the one or more measured quantities may be associated with one time window of the at least one time window or associated with an entirety of the at least one time window. In some aspects, the one or more predicted quantities associated with multiple CSI-RS resources of the set of CSI-RS resources or multiple time windows of the at least one time window may be associated with one CSI report setting of the at least one CSI report setting or multiple CSI report setting of the at least one CSI report setting. In some aspects, the one or more predicted quantities or the one or more measured quantities may include one or more of: a beam blockage prediction, an L1 RSRQ quantity, a SINR quantity, a CQI quantity, or a RI quantity. Each of the beam blockage prediction, the L1 RSRQ quantity, the SINR quantity, the CQI quantity, or the RI quantity may be associated with one or more priorities associated with a dropping rule configured by the base station or the UE. Each of the L1 RSRQ quantity, the SINR quantity, the CQI quantity, or the RI quantity may include a drop rate, an improve rate, a variance, a confidence level or interval, or Doppler information, where each of the drop rate, the improve rate, the variance, the confidence level or interval, or the Doppler information may be associated with one priority of the one or more priorities, and where a first priority of the one or more priorities associated with a first time window closer to a present time of the at least one time window may be higher than a second priority of the one or more priorities associated with a second time window further to the present time of the at least one time window.

In some aspects, as part of 1506, the UE may drop one or more of the drop rate, the improve rate, the variance, the confidence level or interval, or the Doppler information based on associated priorities of the one or more priorities. In some aspects, the one or more predicted quantities or the one or more measured quantities may include a beam blockage prediction associated with one or more candidate beams associated with one or more candidate RSs for the at least one future time window. In some aspects, the one or more candidate beams associated with the one or more candidate RSs may be configured by the CSI resource setting, and the one or more RSs correspond with or do not correspond with the set of CSI-RS resources. In some aspects, the one or more candidate beams may be reported in a second CSI report or MAC-CE linked with a CSI report carrying the one or more predicted quantities, and the CSI report setting may identify the link. In some aspects, the one or more candidate beams may be reported in a CSI report carrying the one or more predicted quantities. In some aspects, a number associated with at least one CPU associated with a beam blockage prediction associated with the one or more predicted quantities or the one or more measured quantities may be based on a number associated with the set of CSI-RS resources. In some aspects, the number associated with the at least one CPU may be further based on a parameter configured by the base station, the UE, or a configuration without signaling from the base station or the UE. In some aspects, a number associated with at least one CPU associated with a beam blockage prediction associated with the one or more predicted quantities or the one or more measured quantities may be based on a difference between a starting point of the at least one future time window and a present time. In some aspects, the number associated with the at least one CPU may be further based on a parameter configured by the base station, the UE, or a configuration without signaling from the base station or the UE. In some aspects, a number associated with at least one CPU associated with a beam blockage prediction associated with the one or more predicted quantities may be based on a number of RSs associated with the beam blockage prediction and not associated with the one or more predicted quantities.

At 1508, the UE may receive, from the base station, one or more RSs not associated with the one or more predicted quantities and associated with the at least one CSI report setting. The one or more RSs may be CSI-RS resources or cell-specific DM-RSs. The one or more RSs may be associated with a cell associated with the one or more predicted quantities or a different cell. For example, the UE 1002 may receive, from the base station, one or more RSs (e.g., 1010) not associated with the one or more predicted quantities and associated with the at least one CSI report setting. In some aspects, 1508 may be performed by beam component 1842 in FIG. 18.

In some aspects, the CSI resource setting may further indicate the timing relationship associated with the stop or resume associated with the monitoring of the set of CSI-RS resources. At 1510, the UE may receive, from the base station, an expire timer associated with resume monitoring or monitoring of a resume command. For example, the UE 1002 may receive, from the base station, an expire timer associated with resume monitoring or monitoring of a resume command. In some aspects, 1510 may be performed by beam component 1842 in FIG. 18.

At 1512, the UE may receive, from the base station, a TCI state associated with a resource including the resume command. For example, the UE 1002 may receive, from the base station 1004, a TCI state associated with a resource including the resume command. In some aspects, 1512 may be performed by beam component 1842 in FIG. 18.

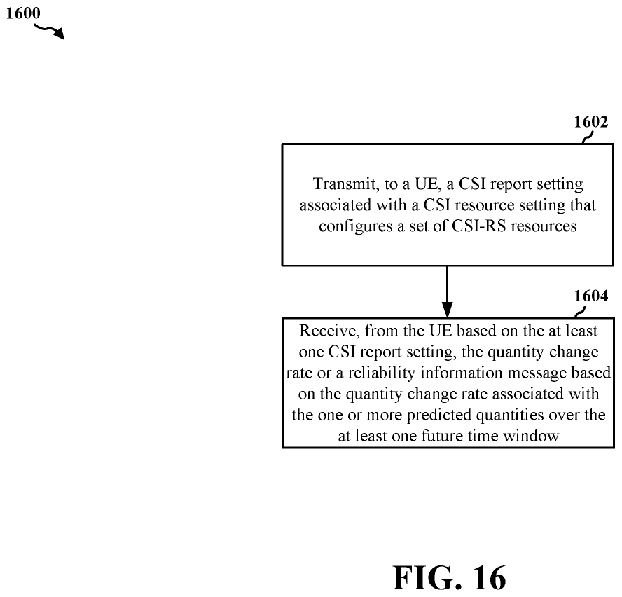

FIG. 16 is a flowchart 1600 of a method of wireless communication. The method may be performed by a base station (e.g., the base station 102/180, 402, 504A/B, 1004; the apparatus 1902).

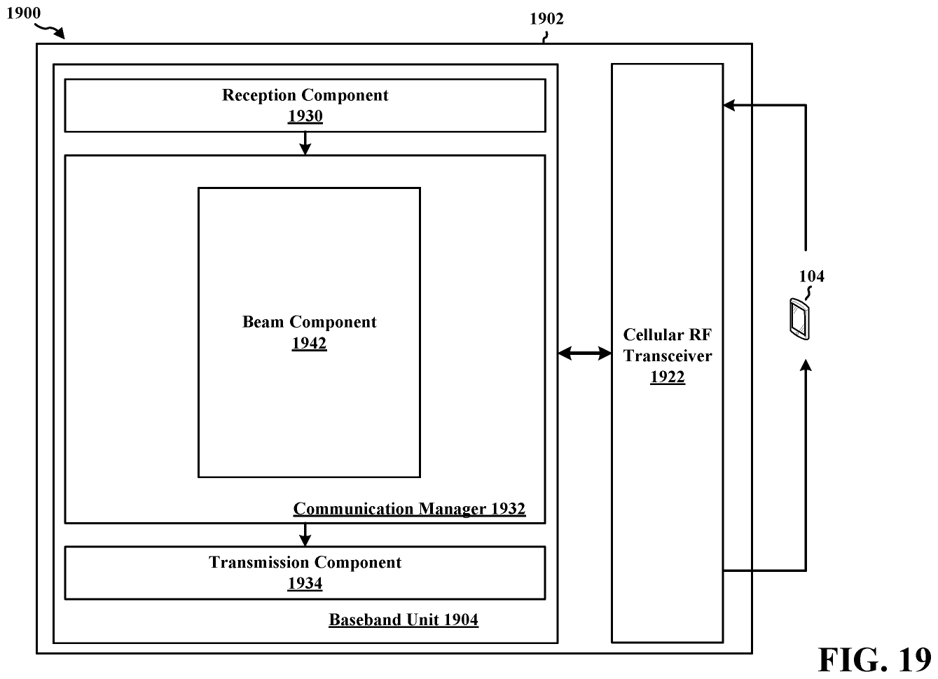

At 1602, the base station may transmit, to a UE, at least one CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities may be associated with the set of CSI-RS resources. For example, the base station 1004 may transmit, to the UE 1002 at least one CSI report setting (e.g., 1006) associated with a CSI resource setting (e.g., 1008) that configures a set of CSI-RS resources. In some aspects, 1602 may be performed by beam component 1942 in FIG. 19.

At 1604, the base station may receive, from the UE based on the at least one CSI report setting, the quantity change rate or a reliability information message based on the one or more predicted quantities over the at least one future time window. For example, the UE 1002 may transmit, to the base station based on the at least one CSI report setting, the quantity change rate or a reliability information message based on the one or more predicted quantities over the at least one future time window. In some aspects, 1604 may be performed by beam component 1942 in FIG. 19.

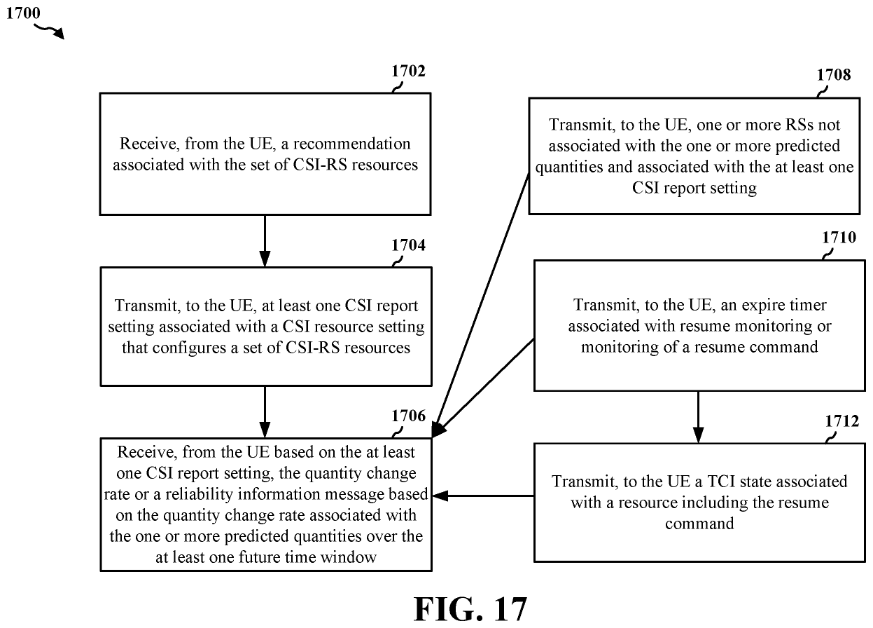

FIG. 17 is a flowchart 1700 of a method of wireless communication. The method may be performed by a base station (e.g., the base station 102/180, 402, 504A/B, 1004; the apparatus 1902).

At 1702, the base station may receive, from the UE, a recommendation associated with the set of CSI-RS resources. The set of CSI-RS resources may be configured based on the recommendation. For example, the base station 1004 may receive, from the UE 1002, a recommendation associated with the set of CSI-RS resources. The set of CSI-RS resources may be configured based on the recommendation. In some aspects, 1702 may be performed by beam component 1942 in FIG. 19. In some aspects, the recommendation or the CSI resource setting may be periodically, semi-persistently, or dynamically transmitted or configured. In some aspects, the recommendation or the CSI resource setting may further indicate a timing relationship associated with a stop or resume associated with a monitoring of the set of CSI-RS resources.

At 1704, the base station may transmit, to a UE, at least one CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities may be associated with the set of CSI-RS resources. For example, the base station 1004 may transmit, to a UE 1002, at least one CSI report setting (e.g., 1006) associated with a CSI resource setting (e.g., 1008) that configures a set of CSI-RS resources. In some aspects, 1704 may be performed by beam component 1942 in FIG. 19. In some aspects the one or more predicted quantities or the one or more measured quantities may include one or more of: an L1 RSRQ quantity, a SINR quantity, a CQI quantity, or a RI quantity, and each of the L1 RSRQ quantity, the SINR quantity, the CQI quantity, or the RI quantity may include a drop rate or an improve rate. In some aspects, the at least one quantity change rate may be expressed based on curve fitting to at least one polynomial function or one or more RSRQ values associated with one or more time instances within the at least one future time window or the at least one past time window. In some aspects, the at least one quantity change rate may be associated with Doppler or velocity information associated with a blockage estimated based on the set of CSI-RS resources. In some aspects, at least one length, at least one starting point, or at least one ending point associated with the at least one future time window may be configured by the base station or defined without the base station. In some aspects, the set of CSI-RS resources may be associated with a same serving cell.

At 1706, the base station may receive, from the UE based on the at least one CSI report setting, the quantity change rate or a reliability information message based on the one or more predicted quantities over the at least one future time window. For example, the base station 1004 may receive, from the UE 1002 based on the at least one CSI report setting (e.g., 1006), the quantity change rate or a reliability information message (e.g., 1012) based on the one or more predicted quantities over the at least one future time window. In some aspects, 1706 may be performed by beam component 1942 in FIG. 19. In some aspects, the reliability information message may be further based on one or more of: a percentage value, a variance associated with the at least one quantity change rate, or one or more confidence levels or one or more confidence intervals associated with the at least one quantity change rate. In some aspects, the one or more predicted quantities or the one or more measured quantities may be further based on an L1 filtering method. The filtering method may be based on a definition without signaling from the UE or the base station, a configuration by the base station, or a recommendation of the UE.

In some aspects, the one or more predicted quantities or the one or more measured quantities may be associated with a periodicity of at least one frame. The one or more predicted quantities or the one or more measured quantities may include one or more of: a beam blockage prediction, an L1 RSRQ quantity, a SINR quantity, a CQI quantity, or a RI quantity, one or more lengths associated with the one or more time windows, one or more curve-fitting parameters, one or more variance values, one or more confidence levels or confidence intervals. The one or more predicted quantities or the one or more measured quantities may be associated with one time window of the at least one time window or associated with an entirety of the at least one time window. In some aspects, the one or more predicted quantities associated with multiple CSI-RS resources of the set of CSI-RS resources or multiple time windows of the at least one time window may be associated with one CSI report setting of the at least one CSI report setting or multiple CSI report setting of the at least one CSI report setting. In some aspects, the one or more predicted quantities or the one or more measured quantities may include one or more of: a beam blockage prediction, an L1 RSRQ quantity, a SINR quantity, a CQI quantity, or a RI quantity. Each of the beam blockage prediction, the L1 RSRQ quantity, the SINR quantity, the CQI quantity, or the RI quantity may be associated with one or more priorities associated with a dropping rule configured by the base station or the UE. Each of the L1 RSRQ quantity, the SINR quantity, the CQI quantity, or the RI quantity may include a drop rate, an improve rate, a variance, a confidence level or interval, or Doppler information, where each of the drop rate, the improve rate, the variance, the confidence level or interval, or the Doppler information may be associated with one priority of the one or more priorities, and where a first priority of the one or more priorities associated with a first time window closer to a present time of the at least one time window may be higher than a second priority of the one or more priorities associated with a second time window further to the present time of the at least one time window.

In some aspects, the one or more predicted quantities may include a beam blockage prediction associated with one or more candidate beams associated with one or more candidate RSs for the at least one future time window. In some aspects, the one or more candidate beams associated with the one or more candidate RSs may be configured by the CSI resource setting, and the one or more RSs correspond with or do not correspond with the set of CSI-RS resources. In some aspects, the one or more candidate beams may be reported in a second CSI report or MAC-CE linked with a CSI report carrying the one or more predicted quantities, and the CSI report setting may identify the link. In some aspects, the one or more candidate beams may be reported in a CSI report carrying the one or more predicted quantities. In some aspects, a number associated with at least one CPU associated with a beam blockage prediction associated with the one or more predicted quantities or the one or more measured quantities may be based on a number associated with the set of CSI-RS resources. In some aspects, the number associated with the at least one CPU may be further based on a parameter configured by the base station, the UE, or a configuration without signaling from the base station or the UE. In some aspects, a number associated with at least one CPU associated with a beam blockage prediction associated with the one or more predicted quantities may be based on a difference between a starting point of the at least one future time window and a present time. In some aspects, the number associated with the at least one CPU may be further based on a parameter configured by the base station, the UE, or a configuration without signaling from the base station or the UE. In some aspects, a number associated with at least one CPU associated with a beam blockage prediction associated with the one or more predicted quantities may be based on a number of RSs associated with the beam blockage prediction and not associated with the one or more predicted quantities.

At 1708, the base station may transmit, to the UE, one or more RSs not associated with the one or more predicted quantities and associated with the at least one CSI report setting. The one or more RSs may be CSI-RS resources or cell-specific DM-RSs. The one or more RSs may be associated with a cell associated with the one or more predicted quantities or a different cell. For example, the UE 1002 may receive, from the base station, one or more RSs (e.g., 1010) not associated with the one or more predicted quantities and associated with the at least one CSI report setting. In some aspects, 1708 may be performed by beam component 1942 in FIG. 19.

In some aspects, the CSI resource setting may further indicate the timing relationship associated with the stop or resume associated with the monitoring of the set of CSI-RS resources. At 1710, the base station may transmit, to the UE, an expire timer associated with resume monitoring or monitoring of a resume command. For example, the UE 1002 may receive, from the base station, an expire timer associated with resume monitoring or monitoring of a resume command. In some aspects, 1710 may be performed by beam component 1942 in FIG. 19.

At 1712, the base station may transmit, to the UE, a TCI state associated with a resource including the resume command. For example, the base station 1004 may transmit, to the UE 1002, a TCI state associated with a resource including the resume command. In some aspects, 1712 may be performed by beam component 1942 in FIG. 19.

FIG. 18 is a diagram 1800 illustrating an example of a hardware implementation for an apparatus 1802. The apparatus 1802 may be a UE, a component of a UE, or may implement UE functionality. In some aspects, the apparatus 1802 may include a cellular baseband processor 1804 (also referred to as a modem) coupled to a cellular RF transceiver 1822. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The cellular baseband processor 1804 communicates through the cellular RF transceiver 1822 with the UE 104 and/or BS 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the UE 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see 350 of FIG. 3) and include the additional modules of the apparatus 1802.

The communication manager 1832 may include a beam component 1842 that is configured to receive, from a base station, at least one CSI report setting associated with a CSI resource setting that configures a set of CSI-RS resources or transmit, to the base station based on the at least one CSI report setting, the quantity change rate or a reliability information message based on the one or more predicted quantities over the at least one future time window, e.g., as described in connection with 1402 and 1404 in FIG. 14 or 1502 and 1504 in FIG. 15. The beam component 1842 may be further configured to transmit, to the base station, a recommendation associated with the set of CSI-RS resources, e.g., as described in connection with 1502 in FIG. 15. The beam component 1842 may be further configured to receive, from the base station, one or more RSs not associated with the one or more predicted quantities and associated with the at least one CSI report setting, e.g., as described in connection with 1508 in FIG. 15. The beam component 1842 may be further configured to receive, from the base station, an expire timer associated with resume monitoring or monitoring of a resume command, e.g., as described in connection with 1510 in FIG. 15. The beam component 1842 may be further configured to receive, from the base station, a TCI state associated with a resource including the resume command, e.g., as described in connection with 1512 in FIG. 15.

The apparatus may include additional components that perform each of the blocks of the algorithm in the flowcharts of FIGS. 14-15. As such, each block in the flowcharts of FIGS. 14-15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the cellular baseband processor 1804, may include means for performing each block in FIGS. 14-15. The cellular baseband processor 1804 may include means for transmitting, to the base station, a recommendation associated with the set of CSI-RS resources. The cellular baseband processor 1804 may further include means for receiving, from a base station, at least one CSI report setting associated with a CSI resource setting that configures a set of CSI-RS resources. The cellular baseband processor 1804 may further include means for transmitting, to the base station based on the at least one CSI report setting, the quantity change rate or a reliability information message based on the one or more predicted quantities over the at least one future time window. The cellular baseband processor 1804 may further include means for receiving, from the base station, one or more RSs not associated with the one or more predicted quantities and associated with the at least one CSI report setting. The cellular baseband processor 1804 may further include means for receiving, from the base station, an expire timer associated with resume monitoring or monitoring of a resume command. The cellular baseband processor 1804 may further include means for receiving, from the base station, a TCI state associated with a resource including the resume command. The cellular baseband processor 1804 may further include means for dropping one or more of the drop rate, the improve rate, the variance, the confidence level or interval, or the Doppler information based on associated priorities of the one or more priorities. The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 19 is a diagram 1900 illustrating an example of a hardware implementation for an apparatus 1902. The apparatus 1902 may be a base station, a component of a base station, or may implement base station functionality. In some aspects, the apparatus 1802 may include a baseband unit 1904. The baseband unit 1904 may communicate through a cellular RF transceiver 1922 with the UE 104. The baseband unit 1904 may include a computer-readable medium/memory. The baseband unit 1904 is responsible for general processing, including the execution of software stored on the computer-readable medium/memory. The software, when executed by the baseband unit 1904, causes the baseband unit 1904 to perform the various functions described supra. The computer-readable medium/memory may also be used for storing data that is manipulated by the baseband unit 1904 when executing software. The baseband unit 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the baseband unit 1904. The baseband unit 1904 may be a component of the base station 310 and may include the memory 376 and/or at least one of the TX processor 316, the RX processor 370, and the controller/processor 375.

The communication manager 1932 may include a beam component 1942 that may transmit, to the UE, at least one CSI report setting associated with a CSI resource setting that configures a set of CSI-RS resources and receive, from the UE based on the at least one CSI report setting, the quantity change rate or a reliability information message based on the one or more predicted quantities over the at least one future time window, e.g., as described in connection with 1602 and 1604 in FIGS. 16 and 1704 and 1706 in FIG. 17. In some aspects, the beam component 1942 may be further configured to receive, from the UE, a recommendation associated with the set of CSI-RS resources, e.g., as described in 1702 in FIG. 17. In some aspects, the beam component 1942 may be further configured to transmit, to the UE, one or more RSs not associated with the one or more predicted quantities and associated with the at least one CSI report setting, e.g., as described in 1708 in FIG. 17. In some aspects, the beam component 1942 may be further configured to transmit, to the UE, an expire timer associated with resume monitoring or monitoring of a resume command, e.g., as described in 1710 in FIG. 17. In some aspects, the beam component 1942 may be further configured to transmit, to the UE a TCI state associated with a resource including the resume command, e.g., as described in 1712 in FIG. 17.

The apparatus may include additional components that perform each of the blocks of the algorithm in the flowcharts of FIGS. 16-17. As such, each block in the flowcharts of FIGS. 16-17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the baseband unit 1904, may include means for transmitting, to a UE, a CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities may be associated with the set of CSI-RS resources. The baseband unit 1904 may further include means for receiving, from the UE based on the at least one CSI report setting, the predicted quantities or a reliability information message based on the one or more predicted quantities over the at least one future time window. The baseband unit 1904 may further include means for receiving, from the UE, a recommendation associated with the set of CSI-RS resources. The baseband unit 1904 may further include means for transmitting, to the UE, one or more RSs not associated with the one or more predicted quantities and associated with the at least one CSI report setting. The baseband unit 1904 may further include means for transmitting, to the UE, an expire timer associated with resume monitoring or monitoring of a resume command. The baseband unit 1904 may further include means for transmitting, to the UE a TCI state associated with a resource including the resume command. The means may be one or more of the components of the apparatus 1902 configured to perform the functions recited by the means. As described supra, the apparatus 1902 may include the TX Processor 316, the RX Processor 370, and the controller/processor 375. As such, in one configuration, the means may be the TX Processor 316, the RX Processor 370, and the controller/processor 375 configured to perform the functions recited by the means.

Example aspects provided herein may provide signaling mechanisms for supporting reporting of predicted future beam blockage and future candidate beams, reducing beam failures or enabling faster BFR in the future, hence improving communication efficiency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, comprising: a memory; and at least one processor coupled to the memory and configured to: receive, from a base station, at least one CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources; and transmit, to the base station based on the at least one CSI report setting, the quantity change rate or a reliability information message based on the quantity change rate associated with the one or more predicted quantities over the at least one future time window.

Aspect 2 is the apparatus of aspect 1, wherein the one or more predicted quantities or the one or more measured quantities include one or more of: an L1 RSRQ quantity, a SINR quantity, a CQI quantity, or a RI quantity, and wherein each of the L1 RSRQ quantity, the SINR quantity, the CQI quantity, or the RI quantity includes a drop rate or an improve rate.

Aspect 3 is the apparatus of any of aspects 1-2, wherein the at least one quantity change rate is expressed based on curve fitting to at least one polynomial function or one or more RSRQ values associated with one or more time instances within the at least one future time window or the at least one past time window.

Aspect 4 is the apparatus of any of aspects 1-3, wherein the at least one quantity change rate is associated with Doppler or velocity information associated with a blockage estimated based on the set of CSI-RS resources.

Aspect 5 is the apparatus of any of aspects 1-4, wherein the reliability information message is further based on one or more of: a percentage value, a variance associated with the at least one quantity change rate, or one or more confidence levels or one or more confidence intervals associated with the at least one quantity change rate.

Aspect 6 is the apparatus of any of aspects 1-5, wherein at least one length, at least one starting point, or at least one ending point associated with the at least one future time window is configured by the base station or defined without the base station.

Aspect 7 is the apparatus of any of aspects 1-6, wherein the one or more predicted quantities are further based on a L1 filtering method, wherein the filtering method is based on a definition without signaling from the UE or the base station, a configuration by the base station, or a recommendation of the UE.

Aspect 8 is the apparatus of any of aspects 1-7, wherein the set of CSI-RS resources are associated with a same serving cell, and wherein the at least one processor is further configured to: transmit, to the base station, a recommendation associated with the set of CSI-RS resources, wherein the set of CSI-RS resources is configured based on the recommendation.

Aspect 9 is the apparatus of any of aspects 1-8, wherein the recommendation or the CSI resource setting is periodically, semi-persistently, or dynamically transmitted or configured.

Aspect 10 is the apparatus of any of aspects 1-9, wherein the recommendation or the CSI resource setting further indicates a timing relationship associated with a stop or resume associated with a monitoring of the set of CSI-RS resources.

Aspect 11 is the apparatus of any of aspects 1-10, wherein the CSI resource setting further indicates the timing relationship associated with the stop or resume associated with the monitoring of the set of CSI-RS resources, and wherein the at least one processor is further configured to: receive, from the base station, an expire timer associated with resume monitoring or monitoring of a resume command.

Aspect 12 is the apparatus of any of aspects 1-11, wherein the at least one processor is further configured to: receive, from the base station, a TCI state associated with a resource comprising the resume command.

Aspect 13 is the apparatus of any of aspects 1-12, wherein the at least one processor is further configured to: receive, from the base station, one or more RSs not associated with the one or more predicted quantities and associated with the at least one CSI report setting, the one or more RSs being CSI-RS resources or cell-specific DM-RSs, the one or more RSs being associated with a cell associated with the one or more predicted quantities or a different cell.

Aspect 14 is the apparatus of any of aspects 1-13, wherein the one or more predicted quantities are associated with a periodicity of at least one frame, wherein the one or more predicted quantities or the one or more measured quantities include one or more of: a beam blockage prediction, a L1 RSRQ quantity, a SINR quantity, a CQI quantity, or a RI quantity, one or more lengths associated with the one or more time windows, one or more curve-fitting parameters, one or more variance values, one or more confidence levels or confidence intervals, and wherein the one or more predicted quantities are associated with one time window of the at least one time window or associated with an entirety of the at least one time window.

Aspect 15 is the apparatus of any of aspects 1-14, wherein the one or more predicted quantities associated with multiple CSI-RS resources of the set of CSI-RS resources or multiple time windows of the at least one time window is associated with one CSI report setting of the at least one CSI report setting or multiple CSI report settings of the at least one CSI report setting.

Aspect 16 is the apparatus of any of aspects 1-15, wherein the one or more predicted quantities or the one or more measured quantities include one or more of: a beam blockage prediction, a L1 RSRQ quantity, a SINR quantity, a CQI quantity, or a RI quantity, and wherein each of the beam blockage prediction, the L1 RSRQ quantity, the SINR quantity, the CQI quantity, or the RI quantity is associated with one or more priorities associated with a dropping rule configured by the base station or the UE, wherein each of the L1 RSRQ quantity, the SINR quantity, the CQI quantity, or the RI quantity includes a drop rate, an improve rate, a variance, a confidence level or interval, or Doppler information, wherein each of the drop rate, the improve rate, the variance, the confidence level or interval, or the Doppler information is associated with one priority of the one or more priorities, and wherein a first priority of the one or more priorities associated with a first time window closer to a present time of the at least one time window is higher than a second priority of the one or more priorities associated with a second time window further to the present time of the at least one time window.

Aspect 17 is the apparatus of any of aspects 1-16, wherein the at least one processor is further configured to: drop one or more of the drop rate, the improve rate, the variance, the confidence level or interval, or the Doppler information based on associated priorities of the one or more priorities.

Aspect 18 is the apparatus of any of aspects 1-17, wherein the one or more predicted quantities include a beam blockage prediction associated with one or more candidate beams associated with one or more candidate RSs for the at least one future time window.

Aspect 19 is the apparatus of any of aspects 1-18, wherein the one or more candidate beams associated with the one or more candidate RSs are configured by the CSI resource setting, and wherein the one or more RSs correspond with or do not correspond with the set of CSI-RS resources.

Aspect 20 is the apparatus of any of aspects 19, wherein the one or more candidate beams are reported in a second CSI report or MAC-CE linked with a CSI report carrying the one or more predicted quantities, and wherein the CSI report setting identifies the link.

Aspect 21 is the apparatus of any of aspects 1-20, wherein the one or more candidate beams are reported in a CSI report carrying the one or more predicted quantities.

Aspect 22 is the apparatus of any of aspects 1-21, wherein a number associated with at least one CPU associated with a beam blockage prediction associated with the one or more predicted quantities is based on a number associated with the set of CSI-RS resources.

Aspect 23 is the apparatus of any of aspects 1-22, wherein the number associated with the at least one CPU is further based on a parameter configured by the base station, the UE, or a configuration without signaling from the base station or the UE.

Aspect 24 is the apparatus of any of aspects 1-23, wherein a number associated with at least one CPU associated with a beam blockage prediction associated with the one or more predicted quantities is based on a difference between a starting point of the at least one future time window and a present time.

Aspect 25 is the apparatus of any of aspects 1-24, wherein the number associated with the at least one CPU is further based on a parameter configured by the base station, the UE, or a configuration without signaling from the base station or the UE.

Aspect 26 is the apparatus of any of aspects 1-15, wherein a number associated with at least one CPU associated with a beam blockage prediction associated with the one or more predicted quantities is based on a number of RSs associated with the beam blockage prediction and not associated with the one or more predicted quantities.

Aspect 27 is the apparatus of any of aspects 1-16, further comprising a transceiver coupled to the at least one processor.

Aspect 28 is an apparatus for wireless communication at a base station, comprising: a memory; and at least one processor coupled to the memory and configured to: transmit, to a UE, a CSI report setting associated with a CSI resource setting that configures a set of CSI-RS resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources; and receive, from the UE based on the at least one CSI report setting, the predicted quantities or a reliability information message based on the one or more predicted quantities over the at least one future time window.

Aspect 29 is a method of wireless communication for implementing any of aspects 1 to 28.

Aspect 30 is an apparatus for wireless communication including means for implementing any of aspects 1 to 28.

Aspect 31 is a computer-readable medium storing computer executable code, where the code when executed by a processor causes the processor to implement any of aspects 1 to 28.

What is claimed is:

1. An apparatus for wireless communication at a user equipment (UE), comprising:
a memory; and
at least one processor coupled to the memory and configured to:
receive, from a base station, at least one channel status information (CSI) report setting associated with a CSI resource setting that configures a set of CSI reference signal (CSI-RS) resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources; and
transmit, to the base station based on the at least one CSI report setting, the quantity change rate or a reliability information message based on the quantity change rate associated with the one or more predicted quantities over the at least one future time window.

2. The apparatus of claim 1, wherein the one or more predicted quantities or the one or more measured quantities include one or more of: a layer 1 (L1) reference signal received quality (RSRQ) quantity, a signal-to-interference plus noise (SINR) quantity, a channel quality indicator (CQI) quantity, or a rank indicator (RI) quantity, and wherein each of the L1 RSRQ quantity, the SINR quantity, the CQI quantity, or the RI quantity includes a drop rate or an improve rate.

3. The apparatus of claim 1, wherein the at least one quantity change rate is expressed based on curve fitting to at least one polynomial function or one or more reference signal received quality (RSRQ) values associated with one or more time instances within the at least one future time window or the at least one past time window.

4. The apparatus of claim 1, wherein the at least one quantity change rate is associated with Doppler or velocity information associated with a blockage estimated based on the set of CSI-RS resources.

5. The apparatus of claim 1, wherein the reliability information message is further based on one or more of: a percentage value, a variance associated with the at least one quantity change rate, or one or more confidence levels or one or more confidence intervals associated with the at least one quantity change rate.

6. The apparatus of claim 1, wherein at least one length, at least one starting point, or at least one ending point associated with the at least one future time window is configured by the base station or defined without the base station.

7. The apparatus of claim 1, wherein the one or more predicted quantities are further based on a layer 1 (L1) filtering method, wherein the filtering method is based on a definition without signaling from the UE or the base station, a configuration by the base station, or a recommendation of the UE.

8. The apparatus of claim 1, wherein the set of CSI-RS resources are associated with a same serving cell, and wherein the at least one processor is further configured to:
transmit, to the base station, a recommendation associated with the set of CSI-RS resources, wherein the set of CSI-RS resources is configured based on the recommendation.

9. The apparatus of claim 8, wherein the recommendation or the CSI resource setting is periodically, semi-persistently, or dynamically transmitted or configured.

10. The apparatus of claim 8, wherein the recommendation or the CSI resource setting further indicates a timing relationship associated with a stop or resume associated with a monitoring of the set of CSI-RS resources.

11. The apparatus of claim 10, wherein the CSI resource setting further indicates the timing relationship associated with the stop or resume associated with the monitoring of the set of CSI-RS resources, and wherein the at least one processor is further configured to:
receive, from the base station, an expire timer associated with resume monitoring or monitoring of a resume command.

12. The apparatus of claim 11, wherein the at least one processor is further configured to:
receive, from the base station, a transmission configuration indicator (TCI) state associated with a resource comprising the resume command.

13. The apparatus of claim 8, wherein the at least one processor is further configured to:
receive, from the base station, one or more RSs not associated with the one or more predicted quantities and associated with the at least one CSI report setting, the one or more RSs being CSI-RS resources or cell-specific demodulation reference signals (DM-RSs), the one or more RSs being associated with a cell associated with the one or more predicted quantities or a different cell.

14. The apparatus of claim 1, wherein the one or more predicted quantities are associated with a periodicity of at least one frame, wherein the one or more predicted quantities or the one or more measured quantities include one or more of: a beam blockage prediction, a layer 1 (L1) reference signal received quality (RSRQ) quantity, a signal-to-interference plus noise (SINR) quantity, a channel quality indicator (CQI) quantity, or a rank indicator (RI) quantity, one or more lengths associated with the one or more time windows, one or more curve-fitting parameters, one or more variance values, one or more confidence levels or confidence intervals, and wherein the one or more predicted quantities are associated with one time window of the at least one time window or associated with an entirety of the at least one time window.

15. The apparatus of claim 1, wherein the one or more predicted quantities associated with multiple CSI-RS resources of the set of CSI-RS resources or multiple time windows of the at least one time window is associated with one CSI report setting of the at least one CSI report setting or multiple CSI report settings of the at least one CSI report setting.

16. The apparatus of claim 1, wherein the one or more predicted quantities or the one or more measured quantities include one or more of: a beam blockage prediction, a layer 1 (L1) reference signal received quality (RSRQ) quantity, a signal-to-interference plus noise (SINR) quantity, a channel quality indicator (CQI) quantity, or a rank indicator (RI) quantity, and wherein each of the beam blockage prediction, the L1 RSRQ quantity, the SINR quantity, the CQI quantity, or the RI quantity is associated with one or more priorities associated with a dropping rule configured by the base station or the UE, wherein each of the L1 RSRQ quantity, the SINR quantity, the CQI quantity, or the RI quantity includes a drop rate, an improve rate, a variance, a confidence level or interval, or Doppler information, wherein each of the drop rate, the improve rate, the variance, the confidence level or interval, or the Doppler information is associated with one priority of the one or more priorities, and wherein a first priority of the one or more priorities associated with a first time window closer to a present time of the at least one time window is higher than a second priority of the one or more priorities associated with a second time window further to the present time of the at least one time window.

17. The apparatus of claim 16, wherein the at least one processor is further configured to:
drop one or more of the drop rate, the improve rate, the variance, the confidence level or interval, or the Doppler information based on associated priorities of the one or more priorities.

18. The apparatus of claim 1, wherein the one or more predicted quantities include a beam blockage prediction associated with one or more candidate beams associated with one or more candidate RSs for the at least one future time window.

19. The apparatus of claim 18, wherein the one or more candidate beams associated with the one or more candidate RSs are configured by the CSI resource setting, and wherein the one or more RSs correspond with or do not correspond with the set of CSI-RS resources.

20. The apparatus of claim 18, wherein the one or more candidate beams are reported in a second CSI report or medium access control (MAC) control element (MAC-CE) linked with a CSI report carrying the one or more predicted quantities, and wherein the CSI report setting identifies the link.

21. The apparatus of claim 18, wherein the one or more candidate beams are reported in a CSI report carrying the one or more predicted quantities.

22. The apparatus of claim 1, wherein a number associated with at least one CSI processing unit (CPU) associated with a beam blockage prediction associated with the one or more predicted quantities is based on a number associated with the set of CSI-RS resources.

23. The apparatus of claim 22, wherein the number associated with the at least one CPU is further based on a parameter configured by the base station, the UE, or a configuration without signaling from the base station or the UE.

24. The apparatus of claim 1, wherein a number associated with at least one CSI processing unit (CPU) associated with a beam blockage prediction associated with the one or more predicted quantities is based on a difference between a starting point of the at least one future time window and a present time.

25. The apparatus of claim 24, wherein the number associated with the at least one CPU is further based on a parameter configured by the base station, the UE, or a configuration without signaling from the base station or the UE.

26. The apparatus of claim 1, wherein a number associated with at least one CSI processing unit (CPU) associated with a beam blockage prediction associated with the one or more predicted quantities is based on a number of RSs associated with the beam blockage prediction and not associated with the one or more predicted quantities.

27. The apparatus of claim 1, further comprising a transceiver coupled to the at least one processor.

28. An apparatus for wireless communication at a base station, comprising:
a memory; and
at least one processor coupled to the memory and configured to:
transmit, to a user equipment (UE), a channel status information (CSI) report setting associated with a CSI resource setting that configures a set of CSI reference signal (CSI-RS) resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources; and
receive, from the UE based on the at least one CSI report setting, the predicted quantities or a reliability information message based on the one or more predicted quantities over the at least one future time window.

29. A method for wireless communication at a user equipment (UE), comprising:
receiving, from a base station, at least one channel status information (CSI) report setting associated with a CSI resource setting that configures a set of CSI reference signal (CSI-RS) resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources; and
transmitting, to the base station based on the at least one CSI report setting, the quantity change rate or a reliability information message based on the one or more predicted quantities over the at least one future time window.

30. A method for wireless communication at a base station, comprising:
transmitting, to a user equipment (UE), at least one channel status information (CSI) report setting associated with a CSI resource setting that configures a set of CSI reference signal (CSI-RS) resources, the at least one CSI report setting including at least one quantity change rate associated with one or more predicted quantities over at least one future time window or one or more measured quantities over at least one past time window, the one or more predicted quantities or the one or more measured quantities being associated with the set of CSI-RS resources; and
receiving, from the UE based on the at least one CSI report setting, the predicted quantities or a reliability information message based on the one or more predicted quantities over the at least one future time window.
